(19) United States
(12) Patent Application Publication
(10) Pub. No.: US 2011/0023322 A1
(43) Pub. Date: Feb. 3, 2011

(54) CLOTHES DRYER

(75) Inventor: Michael Zinke, Postbauer-Heng (DE)

Correspondence Address: LERNER GREENBERG STEMER LLP, P O BOX 2480, HOLLYWOOD, FL, 33022-2480, US

(73) Assignee: DIEHL AKO STIFTUNG & CO. KG, Wangen (DE)

(21) Appl. No.: 12/902,258

(22) Filed: Oct. 12, 2010

Related U.S. Application Data
(63) Continuation of application No. PCT/EP2009/002583, filed on Apr. 8, 2009.

(30) Foreign Application Priority Data
Apr. 11, 2008 (DE) 10 2008 018 356.3

(51) Int. Cl. F26B 3/02; D06F 58/04

(52) U.S. Cl. 34/499; 34/132

(57) ABSTRACT

A clothes dryer has a rotatably mounted drying drum for accommodating clothes to be dried and a drive motor for rotary driving of the drying drum. Accordingly, the drive motor for the drying drum is a single-phase or polyphase electric motor, and a frequency converter is provided for activating the electric motor.

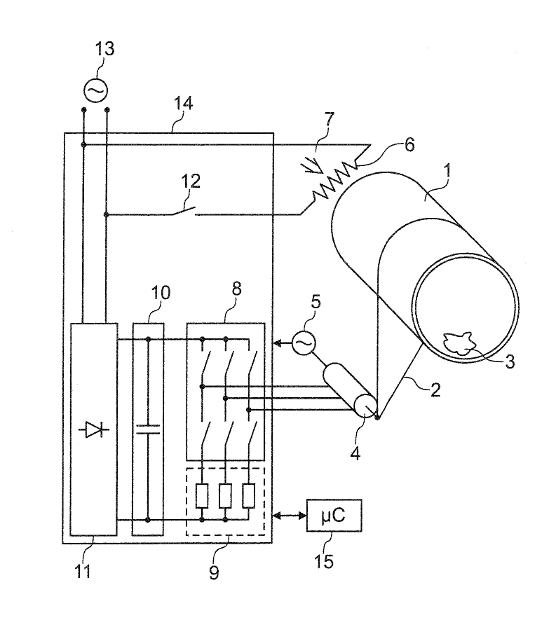

### CROSS-REFERENCE TO RELATED APPLICATION

This is a continuation application, under 35 U.S.C. §120, of copending international application No. PCT/EP2009/002583, filed Apr. 8, 2009, which designated the United States; this application also claims the priority, under 35 U.S.C. §119, of German patent application No. DE 10 2008 018 356.3, filed Apr. 11, 2008; the prior applications are herewith incorporated by reference in their entirety.

### BACKGROUND OF THE INVENTION

### Field of the Invention

The present invention relates to a clothes dryer.

The rotary driving of the drying drum is generally performed by an asynchronous motor with an auxiliary winding which can be operated on a single phase on the power supply system. The phase shift in the current in the auxiliary winding which is required for generating the rotating field is performed in a known manner by a capacitor being connected in series or is brought about by different resistance ratios of the primary and auxiliary windings. The drive motor for the drying drum generally runs at a fixed, load-dependent speed and at the same time is used for driving a process air fan or a cooling air fan, as is described in German patent DE 199 04 993 C2 or published, non-prosecuted German patent application DE 10 2004 055 927 A1, for example. In general, the drive motor is equipped with a thermostat so as to avoid overheating of the drive motor when the drive is blocked or overloaded.

In order to optimize the drying process, various sensor arrangements for detecting different parameters are also known. For example, the temperature of the process air through the drying drum or the electrical resistance of the clothes in the drying drum can be detected in order to determine the degree of drying of the clothes (see German patent DE 199 04 993 C2). In addition, the load quantity in the drying drum can be concluded from the response of a speed of the drive motor during braking and acceleration operations (see published, non-prosecuted German patent application DE 199 28 657 A1 (corresponding to U.S. Pat. No. 6,505,369) and German patent DE 103 05 675 B3, corresponding to U.S. Pat. No. 7,162,759).

### SUMMARY OF THE INVENTION

It is accordingly an object of the invention to provide a clothes dryer which overcomes the above-mentioned disadvantages of the prior art devices and methods of this general type, which has a rotatably mounted drying drum which enables improved operation with respect to known clothes dryers. A further object of the invention is to provide an improved method for operating a clothes dryer with a rotatably mounted drying drum.

With the foregoing and other objects in view there is provided, in accordance with the invention a clothes dryer. The clothes dryer containing a rotatably mounted drying drum for accommodating clothes to be dried, and a drive motor for rotational driving the drying drum. The drive motor is a single-phase electric motor or a polyphase electric motor. A frequency converter is connected to and activates the electric motor.

The clothes dryer has a rotatably mounted drying drum for accommodating clothes to be dried (load) and a drive motor for rotary driving of the drying drum. According to the invention, the drive motor is a single-phase or polyphase electric motor, which is activated by a frequency converter.

Since an electric motor activated by a frequency converter is suitable for variable-speed driving, the rotary driving of the drying drum can in each case be performed at the speed which is optimum for the current operating mode (drying program, operational state) of the clothes dryer, as a result of which the drying process of the clothes dryer can be improved and the operational reliability of the clothes dryer can be increased.

In one configuration of the invention, the frequency converter contains a power activation device for the single-phase or polyphase electric motor and a phase current measurement apparatus for detecting the phase currents and/or phase voltages. Alternatively or preferably in addition, a speed measurement apparatus for detecting the speed and/or a position measurement apparatus for detecting the rotary angle of the electric motor is/are also provided.

For example, an increased mechanical load on the electric motor can be determined on the basis of the detected phase currents and/or phase voltages and/or the detected speed and/or the rotary angle of the electric motor, with the result that the electric motor can be disconnected, if appropriate, before the motor winding reaches impermissibly high temperatures.

Also by way of example, a load quantity and/or a load type of the drying drum can be determined on the basis of the detected phase currents and/or the detected phase voltages and/or the detected speed and/or the detected rotary angle of the electric motor. Likewise, a degree of drying of the clothes in the drying drum can be determined on the basis of the detected phase currents and/or the detected phase voltages and/or the detected speed and/or the detected rotary angle of the electric motor. The drying process of the clothes dryer can then be optimized for the parameters thus determined.

In a further configuration of the invention, in addition, a heater for heating a process air through the drying drum is provided, and a switching device for switching the heater on and off is associated with this heater. The switching device is optionally integrated in the frequency converter or in a main controller of the clothes dryer.

For example, blocking of the electric motor for the drying drum can be determined on the basis of the detected phase currents and/or the detected phase voltages and/or the detected speed and/or the detected rotary angle of the electric motor, with the result that the heater can be disconnected, if appropriate, for safety reasons.

Likewise, faulty rotary driving of the drying drum by the electric motor (for example torn or dropped belt) can be determined on the basis of the detected phase currents and/or the detected phase voltages and/or the detected speed and/or the detected rotary angle of the electric motor, with the result that the heater can be disconnected, if appropriate, for safety reasons.

In yet a further configuration of the invention, in addition, a process air fan for blowing a process air through the drying drum is provided. The drive motor of the drying drum can then also be configured for driving the process air fan in order to achieve a compact configuration of the entire drive of the clothes dryer.

Alternatively, it is also possible for a drive motor which is separate from the drive motor for the drying drum to be provided for driving the process air fan. This variant has the advantage that the speeds for driving the drying drum and for driving the process air fan can be controlled independently of one another and therefore in a manner which is optimized in each case.

Other features which are considered as characteristic for the invention are set forth in the appended claims.

Although the invention is illustrated and described herein as embodied in a clothes dryer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a simplified illustration of a configuration of a clothes dryer according to the invention.

### DETAILED DESCRIPTION OF THE INVENTION

Referring now to the single FIGURE of the drawing in detail, there is shown a drying drum 1 of a clothes dryer which can be loaded in a known manner with clothes 3 to be dried. The drying drum 1 is mounted rotatably in a housing of the clothes dryer and is driven in rotary fashion by a drive motor 4 via a belt 2.

The drive motor 4 for the drying drum 1 is generally a single-phase or polyphase electric motor. In particular, three-phase electric motors, such as three-phase asynchronous motors, brushless DC motors, permanent magnet AC motors or brushless permanent magnet motors, for example, are suitable for the drive motor 4, without the invention being restricted to these specific motor types. The invention will be explained in detail by way of example below using the example of a three-phase asynchronous motor.

The drive motor 4 for the drying drum 1 is activated by a frequency converter 14. The frequency converter 14 has, for this purpose, a system connection 13, a system rectifier 11 connected thereto, a three-phase power activation device 8, which is connected downstream of the system rectifier 11, and an intermediate circuit capacitor 10, which is connected between the system rectifier 11 and the power activation device 8. Since the configuration and mode of operation of such a frequency converter 14 are sufficiently well known to a person skilled in the art, a more detailed description of this is not necessary. In addition, a person skilled in the art will be able to easily adapt the frequency converter 14 to the respective electric motor 4 for driving the drying drum 1.

The frequency converter 14 is preferably coupled to a main controller 15 of the clothes dryer (for example by means of serial bus communication). The main controller 15 generally contains a microcontroller and, for its part, is connected to an input apparatus, via which a user can select a drying program, for example.

The use of a single-phase or polyphase electric motor as a drive motor 4 for the drying drum 1 enables variable speed control, with the result that the speed can be adapted as an additional degree of freedom for different drying programs, for example in optimized fashion for different load quantities and load types and time and temperature profiles. In addition, when starting and stopping the rotary driving of the drying drum, the mechanical load on the drive system (in particular on the belt 2) and the development of noise can be reduced.

In addition, the clothes dryer has a non-illustrated process air fan for blowing a process air 7 through the drying drum 1 and a heater 6 for heating the process air 7. As illustrated in the FIGURE, the heater 6 is likewise connected to the system connection 13 of the clothes dryer, with a switching device 12 for switching the heater 6 on and off being provided in the feed lines. The switching device 12 is used in particular for a safety-related disconnection of the heater 6, wherein different operating states of the clothes dryer or the components thereof can make disconnection of the heater necessary or desirable. The switching device 12 associated with the heater 6 of the process air 7 can be integrated in the frequency converter 14, for example, as in the exemplary embodiment shown, or else can be arranged in the main controller 15.

Either the drive motor 4 for the drying drum 1 or a non-illustrated separate drive motor can be used for driving the process air fan. In the former case of a common drive motor 4, a compact configuration is produced, as is known from German patent DE 199 04 993 C2 and non-prosecuted German patent application DE 10 2004 055 927 A1 mentioned at the outset, for example. The drive motor 4 is then used in the case of a condenser clothes dryer generally also for driving a non-illustrated cooling air fan for a heat exchanger of a condensing device.

Preferably, however, a drive motor which is separate from the drive motor 4 for the drying drum 1 is used for the process air fan (and the cooling air fan). Advantageously, a single-phase or polyphase electric motor is likewise used for this drive motor, with the result that the fan can be operated at a variable speed. In this way, for example, the process air flow 7 can be matched to the aerodynamic resistance of the exhaust channel or the air quantity profile in the further program sequence can be optimized. It is of course also possible, however, to use, for example, an asynchronous motor with an auxiliary winding which can be operated on a single phase on the power supply system for driving the process air fan. In the case of the separate drive motor for the process air fan, this drive motor is advantageously also used for a cooling air fan of a condenser clothes dryer. In principle, however, the use of in total three separate drive motors for these components is also conceivable.

By using separate drive motors for the drying drum 1 and the process air fan (and possibly the cooling air fan), independence of the respective speeds is provided. As a result, for example, a standstill state or a reversing state (with low aerodynamic efficiency) of the process air fan can be avoided in the breaks between reversing and during reversing, which would necessarily result in the case of a common drive motor 4.

A speed measurement apparatus 5 for detecting the speed of the drive motor 4 and a phase current measurement apparatus 9, which is integrated in the frequency converter 14, for detecting the motor currents applied to the three phases of the drive motor 4 by the power activation device 8 of the frequency converter 14 are provided as sensory elements in the clothes dryer. The clothes dryer can naturally additionally be provided with further sensor arrangements which are known from conventional clothes dryers (for example sensors for measuring voltage, current, power, torque, temperature, weight etc.).

The two mentioned measurement apparatuses 5 and 9 are generally provided in any case in the case of a polyphase electric motor 4 which is activated by a frequency converter 14, with the result that a standard motor without any need for modifications can be used for the drive motor 4 of the clothes dryer (sensorless variant).

Different operational sequences of the clothes dryer with the above configuration will now be explained which can be implemented, in addition to the known standard program sequences of a clothes dryer, as a result of the design according to the invention.

We now discuss a safety-related disconnection of the heater in the event of a blocked drive motor.

If a standstill state of the drive motor 4 is identified by the speed measurement apparatus 5 and/or by evaluation of the motor feed variables detected by the phase current measurement apparatus 9 even though a rotating field is provided by the power activation device 8 of the frequency converter 14, the heater 6 is disconnected by the switching device 12. This ensures that items of clothing 3 which are located in the vicinity of the air inlet cannot overheat or even catch light as a result of the heater 6, which is generally operated at a high power, when the drying drum 1 is at a standstill.

We now discuss a safety-related disconnection of the heater during faulty driving of the drying drum.

If, during the operation of the clothes dryer, characteristics of the drive motor 4 are determined by the speed measurement apparatus 5 and/or the phase current measurement apparatus 9 which indicate a significantly low mechanical load or a significantly low fluctuation in the actual speed of the drive motor 4, the heater 6 is disconnected by the switching device 12. This is necessary since, in such a case, the drying drum 1 is obviously no longer rotating, which can be caused by a ripped or dropped belt 2. In this case, too, items of clothing 3 in the vicinity of the air inlet of the drying drum 1 can therefore safely be prevented from overheating or even catching light.

We now discuss a safety-related disconnection of the drive motor in the event of an overload.

If, during the operation of the clothes dryer, characteristics of the drive motor 4 are determined by the speed measurement apparatus 5 and/or the phase current measurement apparatus 9 which indicate an excessive mechanical load on the drive motor 4, the drive motor 4 is disconnected via the power activation device 8 of the frequency converter 14 before the motor winding reaches impermissibly high temperatures (thermal motor protection).

We further discuss a load measurement (quantity and type).

If, during operation of the clothes dryer, characteristics of the drive motor 4 are determined by the speed measurement apparatus 5 and/or the phase current measurement apparatus 9, conclusions can be drawn on the load quantity of the drying drum 1 (for example high power→relatively large load quantity) from the absolute values of said characteristics, and conclusions can be drawn on the type of load 3 of the drying drum 1 (for example considerable fluctuations in speed→large items of clothing) from the fluctuation ranges of the characteristics. This information can advantageously be used for optimizing the further program sequence (temperature profile, time profile, etc.). This method can be implemented and evaluated either by the frequency converter 14 itself or using the main controller 15, which may additionally be provided.

More complex speed profiles for determining the load via the determination of the mass moment of inertia of the drying drum are known, for example, from the documents cited at the outset from published, non-prosecuted German patent application DE 199 28 657 A1 and German patent DE 103 05 675 B3.

We lastly do a determination of the degree of drying/degree of water removal of/from the clothes.

If the above-described load measurement is performed not only once (at the start of the program), but continuously during the drying operation, the degree of drying or degree of water removal of/from the clothes 3 in the drying drum 1 can be determined via the load/inertia of mass which decreases over the course of the drying process. This information can advantageously be used to end the drying operation when a predetermined degree of drying or degree of water removal is reached.

1. A clothes dryer, comprising:
a rotatably mounted drying drum for accommodating clothes to be dried;
a drive motor for rotational driving said drying drum, said drive motor being selected from the group consisting of a single-phase electric motor and a polyphase electric motor; and
a frequency converter connected to and activating said electric motor.

2. The clothes dryer according to claim 1, wherein said frequency converter contains a power activation device for one of said single-phase motor and said polyphase electric motor and a phase current measurement apparatus for detecting at least one of phase currents and phase voltages.

3. The clothes dryer according to claim 1, further comprising at least one of a speed measurement apparatus for detecting a speed of said electric motor and a position measurement apparatus for detecting a rotary angle of said electric motor.

4. The clothes dryer according to claim 1, further comprising:
a heater for heating a process air through said drying drum; and
a switching device for switching said heater on and off.

5. The clothes dryer according to claim 4, wherein said switching device for said heater is integrated in said frequency converter.

6. The clothes dryer according to claim 4, further comprising a main controller and said switching device for said heater is integrated in said main controller.

7. The clothes dryer according to claim 1, further comprising a process air fan for blowing a process air through said drying drum, said drive motor of said drying drum also drives said process air fan.

8. The clothes dryer according to claim 1, further comprising:
a process air fan for blowing a process air through said drying drum; and
a further drive motor, which is separate from said drive motor for said drying drum, for driving said process air fan.

9. A method for operating a clothes dryer having a rotatably mounted drying drum for accommodating clothes to be dried and a drive motor for rotary driving of the drying drum, which comprises the steps of:
selecting the drive motor from the group consisting of a single-phase electric motor and a polyphase electric motor; and
activating the electric motor via a frequency converter.

10. The method according to claim 9, wherein the frequency converter detects at least one of phase currents and phase voltages for one of the single-phase electric motor and the polyphase electric motor.

11. The method according to claim 9, which further comprises detecting at least one of a speed of the electric motor and a rotary angle of the electric motor.

12. The method according to claim 10, which further comprises:
determining an increased mechanical load on the electric motor on a basis of at least one of detected phase currents, detected phase voltages, a detected speed of the electric motor and a detected rotary angle of the electric motor; and
disconnecting the electric motor in an event of a determination of an increased mechanical load on the electric motor.

13. The method according to claim 10, which further comprises determining at least one of a load quantity and a load type of the drying drum on a basis of at least one of detected phase currents, detected phase voltages, a detected speed of the electric motor and a detected rotary angle of the electric motor.

14. The method according to claim 10, which further comprises determining at least one of a degree of drying of the clothes and a degree of water removal from the clothes in the drying drum on a basis of at least one of detected phase currents, detected phase voltages, a detected speed of the electric motor and a detected rotary angle of the electric motor.

15. The method according to claim 10, which further comprises:
providing a heater for heating a process air through the drying drum;
determining a blocking of the electric motor on a basis of at least one of detected phase currents, detected phase voltages, a detected speed of the electric motor and a detected rotary angle of the electric motor; and
disconnecting the heater in an event of a determination of blocking of the electric motor.

16. The method according to claim 10, which further comprises:
providing a heater for heating a process air through the drying drum;
determining a faulty rotary driving of the drying drum by the electric motor on a basis of at least one of detected phase currents, detected phase voltages, a detected speed of the electric motor and a detected rotary angle of the electric motor; and
disconnecting the heater in an event of determination of a faulty rotary driving of the drying drum by the electric motor.

17. The method according to claim 9, which further comprises:
providing a process air fan for blowing a process air through the drying drum; and
driving the process air fan via the drive motor for the drying drum.

18. The method according to claim 9, which further comprises:
providing a process air fan for blowing a process air through the drying drum; and
driving the process air fan via a further drive motor which is separate from the drive motor for the drying drum.
